(19) United States
(12) Patent Application Publication
(10) Pub. No.: US 2024/0190551 A1
(43) Pub. Date: Jun. 13, 2024

(54) AN AIRBORNE GAS PROCESSING SYSTEM AND METHOD

(71) Applicant: HIGH HOPES LABS LTD., Jerusalem (IL)

(72) Inventors: Eran OREN, Tel Aviv (IL); Nadav MANSDORF, Jerusalem (IL)

(21) Appl. No.: 18/556,454

(22) PCT Filed: Apr. 21, 2022
(86) PCT No.: PCT/IL22/50415

§ 371 Date: Oct. 20, 2023

Related U.S. Application Data
(60) Provisional application No. 63/178,142, filed on Apr. 22, 2021.

(51) Int. Cl. B64B 1/40; B64D 1/08; C10G 2/00

(52) U.S. Cl. CPC B64B 1/40; B64D 1/08; C10G 2/50

(57) ABSTRACT

A system and method configured for airborne processing of captured gaseous matter from the earth's atmosphere while utilizing unique high-altitude conditions in order to create a desired substance/s, wherein the operation of said system and method is designated to have an effect on the concentration of at least one gaseous matter in the atmosphere.

### FIELD OF THE INVENTION

The present invention generally relates to climate change mitigation system and method and, more particularly, to system and method for utilizing and processing captured gas from earth's atmosphere using chemical and physical manipulations of captured gas.

### BACKGROUND OF THE INVENTION

Climate change has long been a global concern having a potential enormous impact on the global environment and human wellbeing. Human activities such as the combustion of fossilized fuels and deforestation, along with derivative phenomena such as accelerated permafrost thawing, increase the amount of greenhouse gases in the earth's atmosphere and cause the global climate to change. As a result, many concepts were tested and implemented in order to mitigate the effects of climate change.

Nowadays, the Carbon Dioxide concentration in the earth's atmosphere is 411 parts per million (ppm). This amount increases by over 2 ppm per year, due to the continued emissions in the multiple and distributed sectors of the world's economy. According to the Paris Agreement led by the UNFCCC and signed by most countries in 2015, mankind has to limit the average temperature increase to ‘well below’ 2° C. compared to pre-industrial levels, in order to avoid catastrophic consequences. In order to try and predict how to avoid said potentially catastrophic 2° C. increase limit, models vary between allowing for a remaining carbon quota, but generally aim at remaining below 430 ppm, whereas 450 ppm indicates an approximate transition to a high probability of irreversible effects as one ppm roughly translates to several Billions of metric tons of CO2, this implies the need to remove green-house gases from the atmosphere in the order of tens of billions of tons per year.

Converting harmful greenhouse gases into useful materials bears a great significance to climate crises mitigation prospects. techniques used for carbon dioxide hydrogenation and the potential nature of the resulting chemicals as fuels are known in the art. For example, several publications disclose various techniques related to this field. For example, publications such as EP2152409B1, US20030113244A1 and U.S. Pat. No. 7,863,341B2 teach the generation of synthetic gases usable as energy sources or the intermediates thereof. Other publications such as Rauch, R., Kiennemann, A., & Sauciuc, A. “The Role of Catalysis for the Sustainable Production of Bio-Fuels and Bio-Chemicals”, 2013, disclose processes configured to typically utilize a catalyst such as a metal oxide to convert carbon dioxide into available carbon monoxide for sub synthetic fuels generation techniques as the Fischer-Tropsch process. Other publications such as U.S. Pat. No. 8,212,088B2 and WO2005026093A1 disclose the generation of synthetic fuel gases, liquids such as methanol, ethanol and propanol were shown to be generated, thus providing hydrocarbon derivatives with high energy weight density.

Other carbon dioxide utilization techniques show the generation of polymers and similar value-added materials for the plastics industry and the carbon fiber industry. Publications such as U.S. Pat. No. 8,083,064B2 discloses the use of biological means such as plants to serve as an intermediate towards polymer manufacturing. Publications such as U.S. Ser. No. 10/676,833B2, WO2016064440A1 and US20160108530A1 disclose electrochemical catalytic reduction processes over a variety of electrodes were shown to convert carbon dioxide to hydrocarbons or polymers.

Furthermore, the art has shown methods and utilities to convert carbon dioxide using biological means, similarly to plant photosynthesis, and resulting in such energy dense materials allowing for feedstock in the chemical industry or biofuels. For example, publications such as U.S. Pat. No. 9,938,492B2 and WO2008055190A2 discloses the use of microalgae in different configurations to capture carbon dioxide into said useful materials.

Although the publications disclosed above relate to the field of greenhouse gasses mitigation, they are limited by rate and applicability in large scales, and let alone typically require a high-energy input to initiate and sustain the chemical reactions.

None of said publications teach, alone or in combination, gasses such as carbon dioxide utilization for the purpose of creating commercially viable options to use carbon dioxide and potentially to complete a full cycle of fuels from hydrocarbons use as fuels to emitted carbon dioxide, and back to useful hydrocarbons.

From the state of the art indicated above, one can notice that different trials and development are being conducted, although generally these efforts do not manage to meet the market requirements in terms of price, mitigation (with regard to carbon emissions per ton of carbon dioxide captured and processed) and applicability.

Neither of the publications indicated above do not teach, alone or in combination, an airborne gas processing system, comprising an aerial unit, a payload compartment and pressurized containers configured for utilizing high altitude conditions in order to synthesize a desired substance designated for further use or remote disposal. Moreover, neither of the publications indicated above do not teach, alone or in combination, teaches releasing a desired substance to the surrounding environment in a way that reduces the presence of greenhouse gases contributing to the greenhouse effect.

There is a need to provide a system and method for processing captured greenhouse gases in an economical, scalable and applicable manner in order to produce a desired substance suitable for further use.

There is a further need to provide a system and method configured to release storage means full of desired substance for further processing or use on the ground.

### SUMMARY OF THE INVENTION

The following embodiments and aspects thereof are described and illustrated in conjunction with systems, devices and methods which are meant to be exemplary and illustrative and not limiting in scope. In various embodiments, one or more of the above-described problems have been reduced or eliminated, while other embodiments are directed to other advantages or improvements.

The present invention provides an airborne gas processing system which is economical and highly scalable with regard to any other available system and method.

Said system and method may further include using the climatic conditions found at high altitude that enable gases' phase transitions at low temperatures and relatively low pressures in order to process gaseous matter such as carbon dioxide into a desirable substance.

Said system and method may further include utilizing high altitude platform/vehicle such as a high-altitude balloon configured to capture and process large amounts of high-altitude gaseous matter such as CO2, wherein said high altitude CO2 concentration tends not to be diluted due to the typical strong winds and resulting advection.

Said system and method may further include transferring the desirable substance from the aerial unit to the ground for further processing or storage.

Said system and method may further include increasing the gaseous matter collecting and processing efficiency by allowing to capture and process more gaseous matter such as carbon dioxide mass in a single airborne mission hence reducing regular maintenance and ground time intervals.

The following embodiments and aspects thereof are described and illustrated in conjunction with systems, devices and methods which are meant to be exemplary and illustrative and not limiting in scope. In various embodiments, one or more of the above-described problems have been reduced or eliminated, while other embodiments are directed to other advantages or improvements.

According to one aspect, there is provided an airborne gas processing system, comprising: at least one aerial unit configured to be airborne and to carry a payload compartment; at least one gas processing means configured to form a part of the payload compartment; storage means configured to form a part of the payload compartment; a controller configured to control the system's operation; and an energy source configured to enable the system's operation, wherein separated gaseous matter is configured to be processed by the gas processing means and be converted into desirable substance by utilizing unique high-altitude conditions, and wherein the desirable substance synthesis process is designated to reduce the concentration of the separated gaseous matter in the atmosphere.

According to some embodiments, the system further comprising at least one non aerial unit, wherein the aerial unit is configured to transfer desirable substance stored within the storage means to the non-aerial unit.

According to some embodiments, the separated gaseous matter is carbon dioxide/carbon monoxide.

According to some embodiments, the at least one gas processing means is operable while the aerial unit is airborne at an altitude range of 5-40 km.

According to some embodiments, the gas processing means comprises at least one pressure increasing apparatus.

According to some embodiments, the gas processing means comprises chemical catalysts configured to utilize gas processing procedures and may be based on sorbents for carbon dioxide.

According to some embodiments, the gas processing means comprises biological enzymes configured to utilize a desired substance synthesis.

According to some embodiments, the aerial unit is a high-altitude balloon.

According to some embodiments, the aerial unit is configured to be tethered to the non-aerial unit.

According to some embodiments, the aerial unit further comprises self-steering means.

According to some embodiments, the aerial unit is configured to be retrofitted/integrated into the propulsion means to an aerial vehicle.

According to some embodiments, the storage means may be configured to be released from the aerial unit and reach the non-aerial unit.

According to some embodiments, the non-aerial unit comprises a designated landing area configured to capture the at least one storage means.

According to some embodiments, the at least one storage means comprises guidance means configured to guide the at least one storage means from the aerial unit to the non-aerial unit.

According to some embodiments, the non-aerial unit is configured to be located on the ground, on a body of water or on a vessel, wherein a non-aerial unit configured to be located on a body of water may further comprise a docking area.

According to some embodiments, the controller is further configured to generate navigation commands in order to control the aerial unit.

According to some embodiments, the system is further configured to exploit the low temperatures at high altitudes in order to liquefy or solidify the separated gaseous matter and/or the desirable substance.

According to some embodiments, the separated gaseous matter is carbon dioxide.

According to some embodiments, the arial unit is configured to exploit high altitude wind in order to harness an incoming airflow pressure for the purpose of gas processing.

According to some embodiments, the potential energy stored within the storage means may be further utilized by the airborne gaseous matter processing system.

According to some embodiments, the energy source is based on solar energy/wind energy/prestored power reservoir or configured to power the aerial unit by using a wired connection.

According to some embodiments, the gas processing means is configured to convert captured carbon dioxide into hydrocarbons.

According to some embodiments, the hydrocarbons are methanol/ethanol/formic acid/isopropanol/butyl alcohol.

According to some embodiments, the payload compartment comprises an insulated volume configured to store components that may be harmed from exposure to extreme environmental conditions.

According to some embodiments, the payload compartment comprises a non-insulated volume configured to store components that benefit from exposure to extreme environmental conditions.

According to some embodiments, the gas processing means are configured to be stored in the insulated volume.

According to some embodiments, the storage means are configured to be stored in the non-insulated volume.

According to some embodiments, the conversion to desirable substance is configured to be utilized by photocatalysis using sunlight absorbing materials potentially comprising means designated to provide radiation augmentation.

According to some embodiments, the system further contained hydrogen, wherein carbon dioxide and hydrogen are configured to be processed by the gas processing means in a desired stoichiometric ratio in order to create water and wherein the contained hydrogen is potentially compressed by a designated compressing means.

According to some embodiments, the desirable substance is configured to be released to the ambient air.

According to some embodiments, the gas processing means are configured to convert captured carbon dioxide into plastics/carbon fibers/carbon nano tubes

According to some embodiments, the aerial unit comprises a balloon filled with gas, and wherein said stored gas (potentially hydrogen) is designated to be utilized as a feedstock along with the separated gaseous matter in order to synthesize the desirable substance

According to some embodiments, the system further comprising a panel configured to enable radiation penetration which, in turn, plays a role in the synthesis of the desired substance which may be carbon monoxide or any other substance such as SynGas, methanol, methane, formic acid or any other carbon containing substance.

According to a second aspect, there is provided a method for gas processing using an airborne gas processing system, comprising the steps of: separating at least one designated gaseous matter from the air using an aerial unit, processing the separated gaseous matter using the gas processing means forming a part of the aerial unit and converting the separated gaseous matter into a desirable substance by utilizing unique high-altitude conditions.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention.

In the Figures:

FIG. 1 constitutes schematic perspective views of an arial unit comprising a payload compartment and containers, according to some embodiments of the invention.

FIG. 2 constitutes schematic perspective views of various components forming a payload compartment, according to some embodiments of the invention.

FIG. 3 constitutes schematic perspective views a conversion tank with photocatalytic mechanisms and/or separation mechanisms, according to some embodiments of the invention.

FIG. 4 constitutes schematic perspective views of high surface area available for reaction, according to some embodiment of the invention.

FIG. 5 constitutes a graph depicting the e decay in solar irradiance with decreasing altitude towards sea level.

FIG. 6 constitutes a graph depicting the spectral transmission at different altitudes, pointing out to a significant higher fraction of UV photons available at high altitudes.

FIG. 7 constitutes a graph depicting the increase in Methanol production selectivity with decreasing temperature.

FIG. 8 constitutes a graph depicting showing the increase in CO2 conversion rate with decreasing temperature.

### DETAILED DESCRIPTION OF SOME EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “controlling” “processing,” “computing,” “calculating,” “determining,” “establishing”, “analyzing”, “checking”, “setting”, “receiving”, or the like, may refer to operation(s) and/or process(es) of a controller, a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Unless explicitly stated, the method embodiments described herein are not constrained to a particular order or sequence. Additionally, some of the described method embodiments or elements thereof can occur or be performed simultaneously, at the same point in time, or concurrently.

The term “Controller”, as used herein, refers to any type of computing platform or component that may be provisioned with a Central Processing Unit (CPU) or microprocessors, and may be provisioned with several input/output (I/O) ports, for example, a general-purpose computer such as a personal computer, laptop, tablet, mobile cellular phone, controller chip, SoC or a cloud computing system.

The term “Sequester” as used herein, refers to the trapping of a chemical in the atmosphere or environment and its isolation in a natural or artificial storage area.

The term “A desired substance” as used herein, refers to any substance originated from captured gas that has been process by the airborne gas processing system and is suitable of further use or disposal.

The term “Nonthermal plasma” as used herein, refers to a cold plasma or non-equilibrium plasma is a plasma which is not in thermodynamic equilibrium, because the electron temperature is much hotter than the temperature of heavy species (ions and neutrals) and the surrounding environment. As only electrons are thermalized, their Maxwell-Boltzmann velocity distribution is very different from the ion velocity distribution. When one of the velocities of a species does not follow a Maxwell-Boltzmann distribution, the plasma is said to be non-Maxwellian.

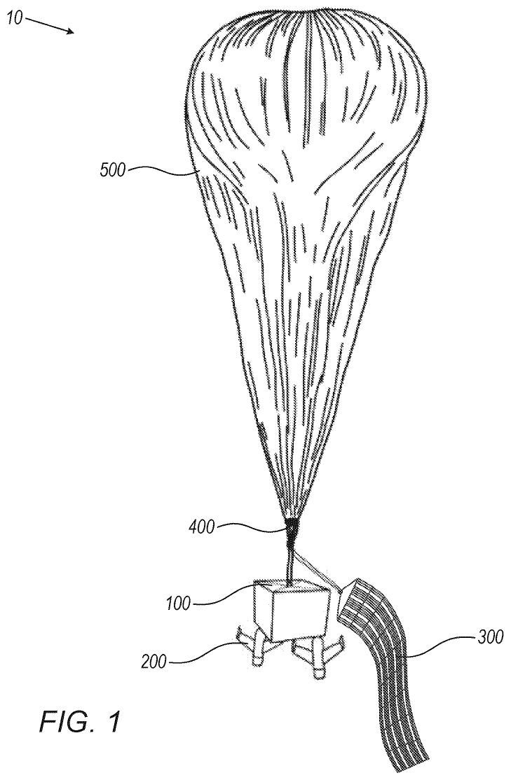

Reference is now made to FIG. 1 which schematically illustrates an aerial unit 10 of an airborne gas processing system. According to some embodiments, the present invention discloses a system and method intended for mitigating the effects of climate change, caused by the emissions of greenhouse gasses into the atmosphere. According to some embodiments, the present invention is designated to utilize at least one aerial unit 10 configured to capture and process gaseous matter such as carbon dioxide from the surrounding atmosphere. According to some embodiments, aerial unit 10, may be a high-altitude balloon, airship, a fixed-wing aircraft, solar powered aircraft, hydrogen powered aircraft, airships, gliding aircraft etc. configured to either capture and convert, or only convert a captured gas into useful material/s and product/s.

Within this context, references are made to carbon dioxide for simplicity of reading and due to the special importance of carbon dioxide in its effects on the earth's climate. However, this is not to imply any limitation of the potential use of the described invention to other gasses such as methane, nitrous oxide, carbon monoxide chlorofluorocarbons and others, whether they affect climate change or not.

According to some embodiments, a non arial (not shown) unit may form a part of airborne gas processing system. According to some embodiments, aerial unit 10 may be configured to fly at altitudes of 5-40 km, wherein the standard temperatures at these altitudes are typically around −50° C. and the air density is approximately 10-30% of those found at sea level.

According to some embodiments, a high-altitude balloon 500 that operates as an aerial unit 10, may be filled with Helium, Hydrogen gas, hot air or any other known substance used to provide aerial lift. According to some embodiments, Aerial unit 10 may be tethered or untethered to the non-aerial unit.

According to some embodiments, aerial unit 10 may be any known aerial vehicle or platform, for example, a powered aircraft (either by internal combustion engine, jet propulsion, solar power or electrical power), a gliding aircraft (such as kite, glider etc.) or an aerostat (such as an airship, balloon, etc.) According to some embodiments, aerial unit 10 may be implemented on an existing aerial vehicle, for example, aerial unit 10 may be retrofitted to a commercial aviation plane to be carried upon or implemented with any section of its fuselage, wings or engines. An aerial unit 10 retrofitted upon an aerial vehicle may further rely on already existing systems, for example, it may use an aircraft's engine built-in compressor as a substitute to an integrated gas processing means (further disclosed below).

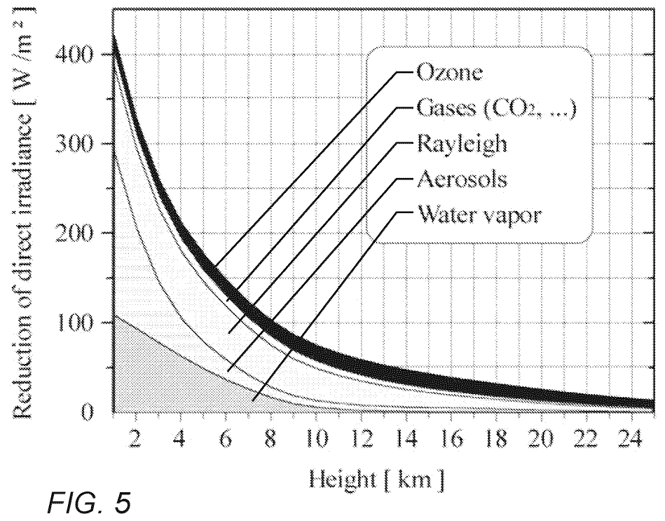

According to some embodiments, the current invention arises and configured to utilize the unique conditions prevailing at high altitudes, for example:
The near-constant winds that allow a constant flow of gases such as carbon dioxide which would have otherwise been diluted when captured or reacted with other substances. Wind, in this context, refers to any motion of atmospheric air in reference to the aerial platform or to the ground;
Low temperatures, typically ranging between −20 degrees Celsius at altitudes of 5 km, to −55 degrees Celsius at altitudes of 15 km, and in some areas across the globe even lower temperatures such as −70 to −90 degrees Celsius at altitudes above 15 km;
A high flux of photons, generally higher by approximately 40% in total energy density when compared to the ground, and consisting of a higher part of short wavelength radiation. The transmission of short wavelengths such as 200-400 nanometer, can be seen to be dramatically higher in high altitudes. This is in part because of Rayleigh scattering in the atmosphere, as well as absorption in the Ozone layer, typically found between altitudes of 10 and 50 km above sea level (as shown, inter alia, in FIG. 5 further disclosed below).

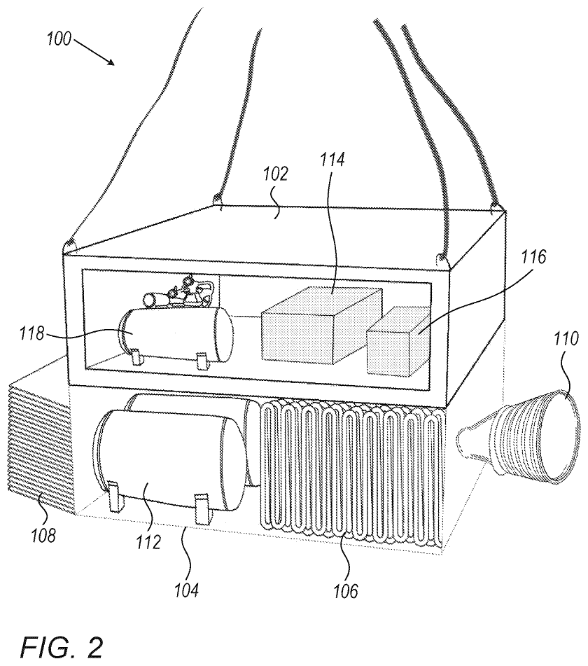

According to some embodiments, aerial unit 10 may comprises payload compartment 100 configured to store at least one gas processing means (shown, inter alia, in FIG. 2), at least one storage means 200, and an energy source 300. According to some embodiments, energy source 300 may be a power reservoir/battery, a hydrogen reservoir (that may simultaneously be used for lift purposes), solar panels/paints/sheets, wind turbines (in order to take advantage of the surrounding strong wind), nuclear power generators, thermal-nuclear power sources in conjunction with thermoelectric elements, etc.

According to some embodiments, a tethered wire connected to the ground, the non-aerial unit or to another airborne vehicle 10 may be configured to provide the energy needed for the operation of aerial unit 10/the airborne gas processing system. According to some embodiments, energy sources 300 may be configured to be carbon neutral or close to it, in order not to contradict the main purpose of carbon dioxide extraction and processing.

According to some embodiments, the processing means are configured to perform a combination of utilization and sequestration. For example, and as disclosed above, aerial unit may comprise the high-altitude balloon 500 typically made of a polymer envelope such as Mylar (biaxially-oriented polyethylene terephthalate, also known as BoPET), filled with a lighter-than-air gas such as Hydrogen, Helium or hot air. According to some embodiments, balloon 500 may comprise an intermediate section 400 (further disclosed in FIG. 4) that may include multiple envelopes nested within each other or connected in parallel to each other (not shown). According to some embodiments, the gas filled envelopes may be connected through wires or cables that may be made in a way to providing some structural integrity, but on the other hand, enabling rupture or disconnection ability when sufficient forces are applied such as in the case of a collision with another aerial vehicle 10, etc.

According to some embodiments, the airborne gas processing system, is configured to process and convert captured carbon dioxide into hydrocarbons, such as methanol and/or ethanol, formic acid, isopropanol, butyl alcohol etc.

According to some embodiments, payload compartment 100 may be configured to include most or all components needed to perform carbon separation from the air (capture) along with processing and/or sequestration. According to some embodiments, this may be done by consuming the gas stored within balloon 500 (such as hydrogen) and using it as an energy source according to some embodiments, alternative energy sources 300 may be utilized such as as solar energy through panels, through heating, wind energy through rotating machinery or through solid state contraptions, organic materials combustion such as fossil fuel burning, thermal-nuclear sources etc. as broadly disclosed above.

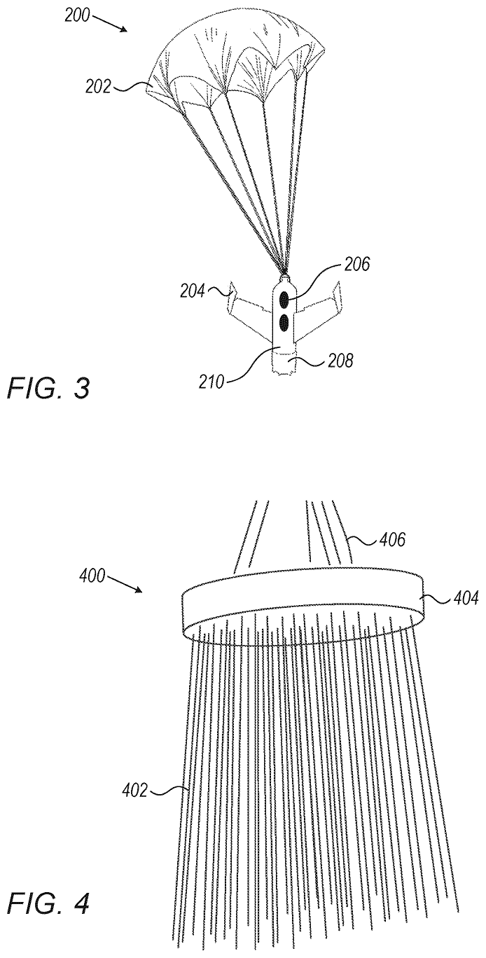

According to some embodiments, collected gas such as carbon dioxide, or alternatively, the desired substance such as SynGas, methanol, methane, formic acid or any other reasonable carbon containing material formed, may be collected into pressurized containers (112 or 200 further disclosed in FIG. 3) and may be thrown off the aerial unit 10 in order to be further sequestrated or utilized.

According to some embodiments, a controller (not shown) is further configured to provide general operational control of the airborne gas processing system. According to some embodiments, the controller may be positioned upon aerial unit 10, upon a non-aerial unit, or may be located elsewhere, for example, on a remote server or as part of cloud computing platform. According to some embodiments, the controller is configured to provide navigation control to aerial unit 10, wherein said navigation control may be conducted automatically or manually by a user monitoring the operation of the airborne gas processing system.

According to some embodiments, aerial unit 10 may further comprise propulsive/steering means (not shown) that can be any known propulsive component configured to provide a controlled aerial deployment of the aerial unit 10. According to some embodiments, the controller may control the propulsive/steering means that may be jet thrusters, rocket propulsion, flaps, propeller of any sort or any other known means of propulsion.

According to some embodiments, the airborne gas processing system further comprises communications means (not shown) configured to provide a reliable and fast communication track between the aerial unit 10 and the non-aerial unit. For example, a communication system that may be controlled by the controller may provide navigation commands to the aerial unit 10 in accordance with various needs or restrains and may be operated either automatically or manually by a monitoring user.

Reference is now made to FIG. 2 which schematically illustrates various components comprising a payload compartment 100. As shown, payload compartment 100 may comprise an insulated volume 102, where heat transfer to and from the surroundings environment is limited by designated insulation in order to keep the temperature within regulated and relatively high. According to some embodiments, insulated volume 102 may be configured to store and maintain the functionality of devices that might be detrimentally affected by low temperatures or winds (e.g. batteries, fuel cells, accurate valves, sensors, compressors, etc.).

According to some embodiments, payload compartment 100 further comprising processing means 118 configured to sequester captured gas such as CO2, meaning eliminating its detrimental presence in the atmosphere and potentially creating desired products or materials. According to some embodiments, said processing means 118 may be integrated throughout compartments and components including in the insulated volume 102, non-insulated volume 104 (disclosed below) or as parts of the flow system and cooling elements 106, 108.

According to some embodiments, payload compartment 100 may comprise a non-insulated volume 104 that may further comprise cooling elements 106 such as heat exchanges and heat sinks 108, That may utilize heat conducting materials with high available surface areas in order to maintain near thermal equilibrium with the surroundings. According to some embodiments, non-insulated volume 104 may further comprises intake nozzle/s 110 configured to inhale gasses for processing.

According to some embodiments, the components which are designated to be stored in the non-insulated volume 104 are designated to benefit from the ‘cold’ environment, for example, in order to capture and further utilize and process gases such carbon dioxide. According to some embodiments, keeping these components in non-insulated compartment 104 enables captured or utilized materials to be kept at low temperatures to avoid unnecessary pressures stress. For example, storage means such as pressurized containers 112 and/or 200 may be held in non-insulated volume 104 or be mounted on the external parts of the payload compartment 100.

According to some embodiments, arial unit 10 and/or payload compartment 100 may include at least one catalyst and a UV-Vis transparent or partly transparent panel (with high yield strength such as, yet not limited to quartz or plastics, etc. that may be incorporated as a ‘window’ mounted on the payload compartment 100. According to some embodiments, said transparent panel may be configured to utilize pressurized CO2 created, for example, by a designated compressor/s configured to create a flow of CO2 gas/liquid and expose it to required temperatures, light and/or hydrogen in order to induce hydrogenation.

According to some embodiments, the hydrogen that may be used for the procedure disclosed above may be stored within balloon 500, meaning, the same gas source may be used for providing lift of aerial unit 10 and for the processing captured gas such as CO2. According to some embodiments, a separate container may be kept at higher pressures and may provide the needed hydrogen to complete the process thereof.

Reference is now made to the following equations:

CO₂+H₂⇄CO+H₂O (1)

nCO+(2n+1)H⇄CₙH₂ₙ₊₂+nH₂O (2)

CO₂+H₂⇄CH₃OH+H₂O (3)

According to some embodiments, and as can be seen in equation (1), the hydrogen and CO2 are configured to be mixed in a desired stoichiometric ratio, to undergo a reaction that typically results in water and a desired substance, such as the reverse water gas shift reaction (known as RWGS). According to some embodiments, the resulting water can be kept in the same reaction vessel or be disposed of outside and away from balloon 500.

According to some embodiments, and as can be seen in equation (2), The resulting carbon monoxide, realistically mixed with hydrogen and CO2, can be used for further reactions such as the Fischer-Tropsch process.

According to some embodiments, and as can be seen in equation (3), other means of hydrogenation and specifically a hydrogenation that leads to the creation of methanol may be conducted. According to some embodiments, said substances may be released should the toxicity and potential greenhouse effects from it or from secondary products be lower than the captured gas. According to some embodiments, the resulting carbon monoxide can also be brought down or released as explained below for the purpose of further utilization.

According to some embodiments, the aerial unit 10 may be configured to ascend to an altitude of 15-40 km above sea level and then release a load of gas such as carbon monoxide. It is stressed that even though carbon monoxide may react with gases in the stratosphere and be oxidized into carbon dioxide, the procedure thereof may prove beneficial should most of the carbon monoxide will remain in the upper stratosphere, or not react under the unique surrounding conditions of temperature, pressure and radiation.

According to some embodiments, and as disclosed above, carbon monoxide may be released from the arial unit 10 in such a way that would result in sequestration of the gas outside of the atmosphere. As carbon monoxide is a gas lighter than the ambient air around it, releasing it may result in its sequestration to higher altitudes, where oxidation to carbon dioxide is unlikely. Thus, sequestering carbon monoxide towards the direction opposite to the force of gravity may be beneficial.

According to some embodiments, utilizing increasing temperatures in lower altitude may be done as a following step to hydrogenate either carbon monoxide or carbon dioxide directly or indirectly. This may be done using designated catalysts as such as copper based catalysts, Fe—Cu catalysts, aluminum and alumina based catalysts, Zn and ZnO micro and nanostructures such as zeolites and Zn based metal organic frameworks, metal organic frameworks used as scaffolds to hold other catalysts, titanium based catalysts, indium based catalysts, gold based, palladium based, zircon and zirconia based, as well as bi-metallic and inter-metallic catalysts, nanometallic meshes, other shapes or porous materials, etc.

According to some embodiments, and following the use of bulk and powder catalysts disclosed above, nano particles can also be used as catalysts, for example, all of the above mentioned catalysts as well as TiO rods, ZnO rods, SrZrO3 particles, core shell metal-metal or metal-semiconductor particles, nano-spheres nano-rods, nano fibers or others, Pd@Au particles, CuIn@SiO2 particles, AuCu@Pt particles, Ni@Al2O3 particles among others, in the variety of potential morphologies and compositions known in the art.

According to some embodiments, solvents of different types may also be used to hydrogenate either carbon monoxide or carbon dioxide directly or indirectly and may serve a part in an electrochemical, electrocatalytic, thermocatalytic or photocatalytic reactions involved in the process thereof.

According to some embodiments, ionic liquids may also be used to hydrogenate either carbon monoxide or carbon dioxide directly or indirectly, and may be chosen to suit the typically cryogenic temperatures and low pressures in which the reaction is designated to occur. According to some embodiments, such ionic liquids may undergo melting in higher temperatures provoked by a heating element, by direct sunlight or by the resulting heat from other processes such as electrical components or cooling or compression processes associated with carbon capture procedures.

According to some embodiments, a part or all of the invested energy in the procedure disclosed above may be provided by harnessing electric or magnetic fields. For example, a sufficiently strong electric field may induce polarity and even further split the CO2 molecules in the gas phase. The relevant fields may be calculated tens of Volts per nanometer, meaning above the dielectric strength of air, but may be more easily applied at high altitudes where the lower density implies higher dielectric strengths. In such cases, CO2 may be split and converted into carbon monoxide or carbonaceous solids. Furthermore, electric or magnetic fields may be used as part of the carbon capture process through induced polarity or by other means.

According to some embodiments, the procedure disclosed above may also be utilized in liquid or dissolved states of carbon dioxide wherein electric fields may be applied through electrochemical means such as electric currents through a solution.

According to some embodiments, utilizing the radiation available at high altitudes for photocatalysis may be augmented by the use of optical devices such as concentrating lenses, transparent materials for the introduction of light into CO2 containers, etc.

According to some embodiment, dedicated containers (such as pressurized container 200) and/or meta-surfaces, meta-lenses, photo-catalyst surfaces, designated powders, suspension or bulk materials configured to allow UV or visible light manipulation may be used for said hydrogenation procedure. According to some embodiment, photonic materials or non-linear photonic components may be used to manipulate the incoming radiation into a desired frequency or bandwidth by the use of second harmonic generation, third harmonic generation, up-conversion, down-conversion, etc.

According to some embodiments and as previously disclosed, the utilizing hydrogen as a feedstock may be conducted by compressing some of the hydrogen used for filing balloon 500 by the incorporation of pumps and compressors. Alternatively, other hydrogen canisters, or separate balloons 500 may be used for this purpose. According to some embodiments, in-situ generation or release of hydrogen through containing materials, hydrates, metal-organic-frameworks, etc. may also serve a role in providing an available hydrogen reservoir.

According to some embodiments, additional substances (for example, ammonia, calcium minerals, magnesium minerals etc.) may be carried by aerial unit 10 as additional reactants or feedstock (and not just as catalysts) for said chemical processes.

According to some embodiments and as previously disclosed, desired substance/s created by chemical processes, may be designated to be (wholly or partly) released, with the purpose of reaching the ground by trickling from the aerial vehicle 10. According to some embodiments, this may be achieved in an environmentally aware manner, by guiding pressurized container/s 200 to a location in which there is no expected harm caused by releasing said substances, or by changing the altitude for this purpose. According to some embodiments, this could also be achieved by limiting the amounts or concentration released in conjunction with sensors mounted on board the aerial unit 10 or on other locations upon the airborne gas processing system. For example, carbonaceous solids are generally safe but should not be inhaled, hence such residue can be compressed into more compact form in order to avoid the dispersion of powdered solids when treated at the ground site, etc.

According to some embodiments, other processes other than hydrogenation may be utilized in order to create a desired substance in the form of plastics, carbon fibers carbon nano tubes, etc. with somewhat similar techniques to the ones disclosed above by utilizing the natural conditions prevailing at heights. According to some embodiments, these desired substances, may serve for the purpose of enabling an improved carbon capture and utilization capabilities. For example, these desired substances may be further used in the production of balloon 500 envelope or any other vessel or component related to the airborne gas processing system or such.

According to some embodiments, since the gas processing means of aerial unit 10 are configured to operate at high altitude, much of the energy generally used to compress ambient air at ground altitude is generally unneeded. According to some embodiments, after the CO2 in the captured and processed gas had been converted to a desired substance, the compressed gas may be further utilized by using its potential stored energy. For example, the potential energy stored within the compressed gas may be used directly to compress further airflow or indirectly to power various electrical/mechanical systems, thus leading to further energy/weight savings.

Reference is now made to FIG. 3 which schematically illustrates pressurized container 200 with photocatalytic mechanisms and/or other separation mechanisms. As shown, pre pressurized container 200 may comprise a mechanism for slowing down its fall, such as a parachute 202 or any other means to increase its surface area or the friction with the air, or alternatively generate lifting force. According to some embodiments, in order to enable container 200 to land at a desired location, wings 204, or nozzles, canards, or pressurized airflow (not shown) may be configured to steer pressurized container 200 on its way, potentially using an additional guidance and navigation means such as global satellite navigation systems (GNSS), local navigation systems, optical tracking etc. According to some embodiments, the controller may be configured to compute and control an efficient and safe navigation route.

According to some embodiments, the pressurized container 200 may contain components configured to enable a reaction with and/or conversion to catalysts or designated substances respectfully, as previously disclosed. For example, hydrogenation or CO2 may be converted to methanol, ethanol etc. according to some embodiments, panel 206 may be transparent or semi-transparent and may have high yield strength such as, yet not limited to, quartz or plastics, etc. and configured to utilize IR or UV radiation in order to enable a reaction thereof. According to some embodiments, panel 206 may be used with incorporation of catalysts such as photo-catalysts or other chemical/electrical reagents in order to enhance a reaction leading to the synthesis of a desired material as disclosed above.

According to some embodiments, said desired substance/s may be brought to the ground directly as disclosed above, or let flow out of the payload compartment in part or entirely through valves or regulators (not shown).

According to some embodiments, and since collected CO2 may be contained within a high-pressurized container 200, after sufficient time, it tends to reach the surrounding temperature through heat conduction from pressurized container 200, meaning in high altitude it may typically reach −50 degrees Celsius. At low temperatures such as these, the chemical hydrogenation of CO2 to a desired substance typically has higher specificities to methanol.

According to some embodiments, in order to increase CO2 processing efficiency, the aerial unit 10 may utilize multiple pressurized containers 200 in parallel, for example, pressurized containers 200 may be aliened in series/in several stages in order to provide an efficient compression and processing of gaseous matter.

Reference is now made to FIG. 4 which schematically illustrates intermediate section 400 previously disclosed in FIG. 1. As shown, conduits 402 may be configured to transfer and store gases such as CO2 and be further configured to stretched from base plate 404 configured to provide structural integrity and lead the flow of gases into conduits 402. According to some embodiments, conduits 402 are completely of partially transparent and configured to be exposed to sunlight radiation at low temperatures in which a desirable reaction may occur.

According to some embodiments, conduits 402 may then serve to separate products and process gas into a desired substance by utilizing photocatalytic or other chemical reactions. According to some embodiments, conduits 402 may be configured with valves, membranes, filters or other mechanical means (not shown).

According to some embodiments, the other side of base plate 404 is configured to be connected to connecting cables 406 which in turn are configured to be connected to balloon 500 envelopes in order to provide possible path to gasses such as pumping gasses into an envelope used for decreasing altitude or in order to enable pulling gasses (such as hydrogen) out of the lifting envelope to provide feedstock for chemical reactions or energy consuming devices sored within the payload compartment 100 as disclosed above.

According to some embodiments, conduits 402 may be configured with high surface areas in order to enable a faster catalytic or photocatalytic reaction. According to some embodiments, conduits 402 may be shaped as long pipes having an internal catalytic layer in order to increase the permeation of sunlight radiation to be used as an energy source for said photocatalytic reaction. According to some embodiments, conduits 402 may be in the shape of different geometries such as, yet not limited to, parallel plates, concentric spheres, jagged surfaces etc.

Reference is now made to FIG. 5 which illustrates a graph depicting the e decay in solar irradiance with decreasing altitude towards sea level. As shown, the vast majority of solar irradiance power is available at altitudes of 15 km and above. It should be noted that while the solar irradiance spectrum peaks at the visible light range, there is a significant energy content in the UV range, and many chemicals as well as electrochemical reactions are more efficient if conducted at said UV energies.

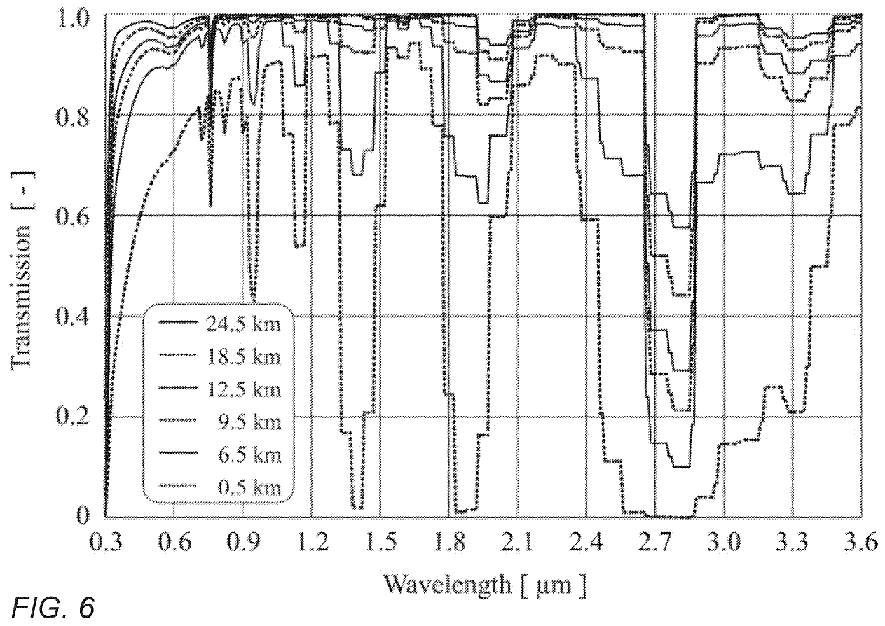

Reference is now made to FIG. 6 which illustrates the spectral transmission at different altitudes and suggesting a significant higher fraction of UV photons available at high altitudes. As shown, the intermittently dashed and continuous lines indicating the energy contents available throughout the UV to IR spectrum. The top line in the graph, indicating the spectral energy contents at an altitude of 24.5 km above sea level and the dashed line immediately adjacent to it showing the spectral energy contents at an altitude of 18.5 km indicate the significantly higher available energy at wavelengths in the UV range 0.3-0.4 micrometer. As further shown, the atmospheric windows and absorption bands varied at different altitudes. From the graph we can clearly see an increased portion of UV photons at high altitude, even as low 12.5 km (as indicated by the continuous line, third counting from the top one). According to some embodiments, an IR and UV radiation absorbed through transparent panel 206 located on pressurized container 200 may correspond with these atmospheric conditions and specifically to short wavelengths of UV light and result in an increased rate of desired substance formation.

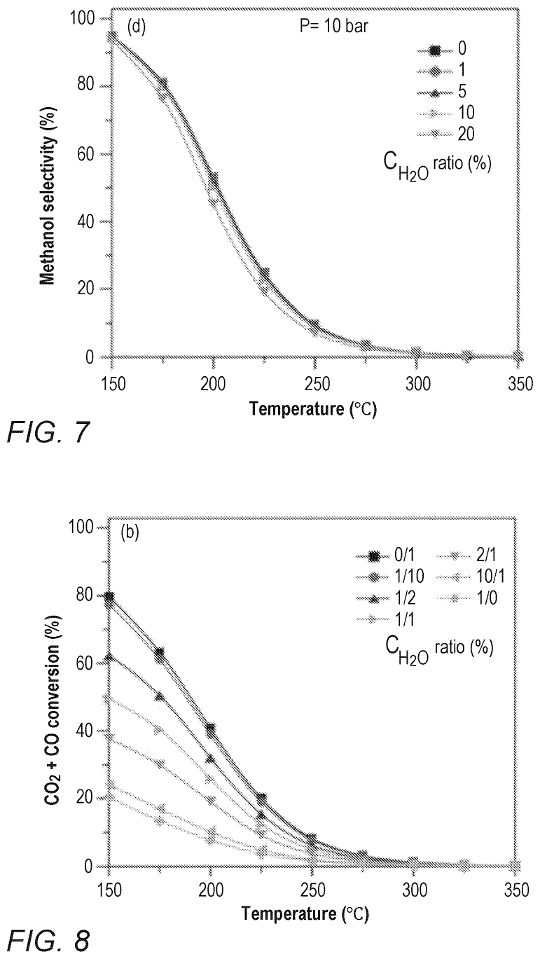

Reference is now made to FIG. 7 which illustrates the increase in Methanol production selectivity with decreasing temperature. As shown, as the temperatures become lower, the selectivity to produce methanol increases. Since Methanol is known to be a potential fuel through both combustion or electrochemical reactions, its production can serve as a high-energy density alternative to fossil fuels such as gasoline or any other fossil fuel. Furthermore, since Methanol can also be synthetically produced by biological means, it can serve as part of a wider Methanol economy offering versatile alternative fuels.

Reference is now made to FIG. 8 which illustrates the increase in CO2 conversion rate to methanol with decreasing temperature. As shown, the reaction having a higher conversion ratio of CO2 as the temperature decreases, meaning that as long as the reaction takes place, the benefit in terms of carbon dioxide utilization increases at lower temperatures. However, typically hydrogenation occurs at relatively high temperatures and pressures and thus may be unfeasible or inefficient at high altitudes. In such a case, and according to some embodiments, the use of non-thermal plasma methods, (in which electrons are effectively at a far higher temperature than the surrounding environment), may be applied, through the applications of strong electric or magnetic field or through the enhancement of electromagnetic fields (and temperatures) via photochemical or plasmonic reactions. In such non-thermal plasma methods, since by definition the electrons are not in thermal equilibrium with the ambient environment, some chemical or electrochemical reactions may take place that would not have otherwise been able to occur or alternatively would have required extremely high temperatures.

According to some embodiments, it may be beneficial to utilize the low temperatures and high solar flux in order to convert CO2 into the desirable substance/s as mentioned above. In order to overcome the high energetic barrier required for the reaction in terms of photocatalysis, the use of the direct sunlight for heating may be incorporated in order to increase the temperature of the carbon dioxide tank to such relatively high temperatures as 100-300 degrees Celsius. According to some embodiments, this may be achieved by the use of sunlight absorbing materials such as dark colors, etc. as well as by isolating the tank physically to prevent heat losses to convection. According to some embodiments, heating and heat preservation may be enhanced with focusing mechanisms such as lenses.

According to some embodiments, the airborne gas processing system itself may include at least one catalyst and a UV-Vis semi-transparent or transparent material with high yield strength such as, yet not limited to quartz or plastics, or alternatively, a UV transparent material can be incorporated as a ‘window’ on the vessel as mentioned above. According to some embodiments, said mechanism may use the pressure from the carbon dioxide pressurized container/s or may utilize an additional pump or pumps designated to move the CO2 gas or liquid and expose it to required temperatures, light and hydrogen for the purpose of promoting hydrogenation.

Although the present invention has been described with reference to specific embodiments, this description is not meant to be construed in a limited sense. Various modifications of the disclosed embodiments, as well as alternative embodiments of the invention will become apparent to persons skilled in the art upon reference to the description of the invention. It is, therefore, contemplated that the appended claims will cover such modifications that fall within the scope of the invention.

1. An airborne gas processing system, comprising:
(i) at least one aerial unit configured to be airborne and to carry a payload compartment;
(ii) at least one gas processing means configured to form a part of the payload compartment;
(iii) storage means configured to form a part of the payload compartment;
(iv) a controller configured to control the system's operation; and
(v) an energy source configured to enable the system's operation,
wherein separated gaseous matter is configured to be processed by the gas processing means and be converted into desirable substance by utilizing unique high-altitude conditions, and
wherein the desirable substance synthesis process is designated to reduce the concentration of the separated gaseous matter in the atmosphere.

2. The system of claim 1, further comprising at least one non aerial unit, wherein the aerial unit is configured to transfer desirable substance stored within the storage means to the non-aerial unit.

3. The system of claim 1, wherein the separated gaseous matter is carbon dioxide.

4. The system of claim 1, wherein the separated gaseous matter is carbon monoxide.

5. The system of claim 1, wherein the at least one gas processing means is operable while the aerial unit is airborne at an altitude range of 5-40 km.

6. The system of claim 1, wherein the gas processing means comprises at least one pressure increasing apparatus.

7. The system of claim 1, wherein the gas processing means comprises chemical catalysts configured to utilize a gas processing procedure.

8. The system of claim 7, wherein the chemical catalysts are based on sorbents for carbon dioxide.

9. The system of claim 1, wherein the gas processing means comprises biological enzymes configured to utilize a desired substance synthesis.

10. The system of claim 1, wherein the aerial unit is a high-altitude balloon.

11. The system of claim 1, wherein the aerial unit is configured to be retrofitted to an aerial vehicle.

12. The system of claim 11, wherein the aerial unit is integrated into the propulsion means of the aerial vehicle.

13. The system of claim 1, wherein the at least one storage means is configured to be released from the aerial unit and reach the non-aerial unit.

14. The system of claim 2, wherein the non-aerial unit comprises a designated landing area configured to capture the at least one storage means.

15. The system of claim 14, wherein the at least one storage means comprises guidance means configured to guide the at least one storage means from the aerial unit to the non-aerial unit.

16. The system of claim 2, wherein the non-aerial unit is configured to be located on the ground.

17. The system of claim 2, wherein the non-aerial unit is configured to be located on a body of water.

18. The system of claim 17, wherein the non-aerial unit further comprises a docking area.

19. The system of claim 2, wherein the non-aerial unit is configured to be located on a vessel.

20. The system of claim 1, wherein the controller is further configured to generate navigation commands in order to control the aerial unit.

21. The system of claim 1, further configured to exploit the low temperatures at high altitudes in order to liquefy or solidify the separated gaseous matter and/or the desirable substance.

22. The system of claim 1, wherein the energy source is based on solar energy.

23. The system of claim 1, wherein the energy source is based on wind energy.

24. The system of claim 1, wherein the energy source is a prestored power reservoir.

25. The system of claim 1, wherein the energy source is configured to power the aerial unit by using a wired connection.

26. The system of claim 1, wherein the gas processing means is configured to convert captured carbon dioxide into hydrocarbons.

27. The system of claim 26, wherein the hydrocarbons are methanol/ethanol/formic acid/isopropanol/butyl alcohol.

28. The system of claim 1, wherein the payload compartment comprises an insulated volume configured to store components that may be harmed from exposure to extreme environmental conditions.

29. The system of claim 1, wherein the payload compartment comprises a non-insulated volume configured to store components that benefit from exposure to extreme environmental conditions.

30. The system of claim 28, wherein the gas processing means are configured to be stored in the insulated volume.

31. The system of claim 29, wherein the storage means are configured to be stored in the non-insulated volume.

32. The system of claim 1, wherein the conversion to desirable substance is configured to be utilized by photocatalysis using sunlight absorbing materials.

33. The system of claim 32, further comprising means designated to provide radiation augmentation.

34. The system of claim 1, further comprising contained hydrogen, wherein carbon dioxide and hydrogen are configured to be processed by the gas processing means in a desired stoichiometric ratio in order to create water.

35. The system of claim 34, wherein the contained hydrogen is compressed by a designated compressing means.

36. The system of claim 1, wherein the desirable substance is configured to be released to the ambient air.

37. The system of claim 1, wherein the gas processing means is configured to convert captured carbon dioxide into plastics/carbon fibers/carbon nano tubes.

38. The system of claim 1, wherein the aerial unit comprises a balloon filled with gas, and wherein said stored gas is designated to be utilized as a feedstock along with the separated gaseous matter in order to synthesize the desirable substance.

39. The system of claim 38, wherein the stored gas is hydrogen.

40. The system of claim 1, further comprising a panel configured to enable radiation penetration which, in turn, plays a role in the synthesis of the desired substance.

41. The system of claim 1, wherein the desired substance is carbon monoxide.

42. A method for gas processing using an airborne gas processing system, comprising the steps of:
(i) separating at least one designated gaseous matter from the air using an aerial unit,
(ii) processing the separated gaseous matter using the gas processing means forming a part of the aerial unit, and
(iii) converting the separated gaseous matter into a desirable substance by utilizing unique high-altitude conditions.
